(19) United States
(12) Patent Application Publication
(10) Pub. No.: US 2023/0212066 A1
(43) Pub. Date: Jul. 6, 2023

(54) Partially or fully non-combustible and vapour permeable pliable building membrane and associated methods

(71) Applicant: Ametalin IP Pte Ltd, Robinson 77 (SG)

(72) Inventors: Craig Lumsden, Salisbury North (AU); Archer Oscar, Salisbury North (AU); Tony Jin, Salisbury North (AU); Michel Bostrom, Salisbury North (AU)

(21) Appl. No.: 18/008,897

(22) PCT Filed: Jun. 1, 2021
(86) PCT No.: PCT/AU2021/050537

§ 371 Date: Dec. 7, 2022

(30) Foreign Application Priority Data
Jun. 9, 2020 (AU) 2020901890

(51) Int. Cl. C03C 25/1095; E04B 1/62; E04B 1/94; C03C 25/305; D06M 15/256

(52) U.S. Cl. CPC C03C 25/1095; E04B 1/625; E04B 1/941; C03C 25/305; D06M 15/256; D06N 2201/087; D06M 2200/30

(57) ABSTRACT

The pliable building membrane 1 is a non-flammable inorganic fabric 2 defining a first planar side 4 and a second opposite planar side 5. A halocarbon polymer in the form of a fluorocarbon polymer 3 is impregnated into the first planar side 4. The halocarbon polymer may be polytetrafluoroethylene (PTFE), fluorin plastic, ethylene tetrafluoroethylene and/or a tetrafluoroethylene perfluoro propylene co-polymer, for example. Various embodiments have differing ratios of halocarbon polymer to non-flammable fabric and this influences its vapour permeability. A suitable minimum target vapour permeability is approximately 0.15 μg/N·s. An embodiment having a 1:1 ratio has a vapour permeability of approximately 1 μg/N·s, which is well suited for use as a sarking-type material. The non-flammable fabric 2 may be a satin-weave fiberglass fabric or other non-flammable fabrics, such as basalt fibre fabric, or carbon fibre fabric, for example.

### I. TECHNICAL FIELD

The present invention relates membranes for use in buildings. Embodiments of the present invention find application, though not exclusively, in the fields of construction and renovation.

### II. BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

Various recent building fires have reinforced the importance of using partially or fully non-combustible materials in construction. This has driven a demand for a non-combustible, or at least combustibility-controlled, pliable building membrane that has properties making it suitable for use as a sarking-type material. Despite this strongly felt demand, to the best of the inventors' knowledge, none of the currently available building wraps, pliable building membranes and sarking-type materials that have properties conducive to commercial acceptance would offer suitable combustibility under the relevant Australian standard.

### III. SUMMARY OF THE INVENTION

It is an object of the present invention to overcome, or substantially ameliorate, one or more of the disadvantages of the prior art, or to provide a useful alternative.

In a first aspect of the present invention there is provided a partially or fully non-combustible and vapour permeable pliable building membrane comprising a halocarbon polymer impregnated non-flammable fabric.

Preferably the halocarbon polymer impregnated non-flammable fabric is a fluorocarbon polymer impregnated non-flammable fabric.

Preferably the non-flammable fabric is an inorganic fabric.

Preferably a ratio of halocarbon polymer to non-flammable fabric, by weight, is between 0.01:1 and 1.4:1. More preferably, the ratio of halocarbon polymer to non-flammable fabric, by weight, is between 0.1:1 and 1:1. In one embodiment the ratio of halocarbon polymer to non-flammable fabric, by weight, is approximately 0.4:1.

Preferably the pliable building membrane has a vapour permeability of at least 0.15 μg/N·s.

In one embodiment the halocarbon polymer contributes a weight per unit area of approximately 200 grams per square meter (gsm) to the building membrane.

In one embodiment the non-flammable fabric is a fibreglass fabric, and preferably a satin-weave fibreglass fabric.

In one embodiment the fibreglass fabric has a weight per unit area of approximately 200 grams per square meter (gsm) prior to being impregnated with the halocarbon polymer.

In another embodiment the non-flammable fabric is a basalt fibre fabric or carbon fibre fabric.

In one embodiment the halocarbon polymer is polytetrafluoroethylene.

In another embodiment the halocarbon polymer is fluorin plastic.

In another embodiment the halocarbon polymer is ethylene tetrafluoroethylene.

In another embodiment the halocarbon polymer is a tetrafluoroethylene perfluoro propylene co-polymer.

In a second aspect of the present invention there is provided a method of forming a partially or fully non-combustible and vapour permeable pliable building membrane including impregnating a halocarbon polymer into a non-flammable fabric in a solvent-borne line process.

Preferably the method includes heating the pliable building membrane so as to evaporate the solvent and thereby concentrate the halocarbon polymer into a solid impregnated into the non-flammable fabric.

In one embodiment of the method the non-flammable fabric defines a first planar side and a second planar side opposite to the first planar side and the halocarbon polymer is impregnated into the first planar side.

In another embodiment the halocarbon polymer is sprayed onto the non-flammable fabric.

In another embodiment the building membrane has uniformly dispersed halocarbon polymer impregnated into the non-flammable fabric.

In another aspect of the present invention there is provided a method of providing a secondary weather barrier that is waterproof, vapour permeable, provides an air barrier and is partially or fully non-combustible, the method including using a pliable building membrane comprising a halocarbon polymer impregnated non-flammable fabric as a sarking-type material.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

The features and advantages of the present invention will become further apparent from the following detailed description of preferred embodiments, provided by way of example only, together with the accompanying drawings.

### IV. BRIEF DESCRIPTION OF THE ACCOMPANYING DRAWINGS

FIG. 1 is a perspective view of an embodiment of the pliable building membrane showing a side of the inorganic fabric into which the halocarbon polymer has been impregnated;

FIG. 2 is a perspective view similar to that of FIG. 1, however with an edge curling back to expose the opposite raw side of the non-flammable fabric;

FIG. 3 is a perspective view of the embodiment of the pliable building membrane showing the raw side of the non-flammable fabric; and

FIG. 4 is a perspective view of a processing station that may be used to impregnate the halocarbon polymer into the non-flammable fabric.

### V. DETAILED DESCRIPTION OF PREFERRED EMBODIMENTS OF THE INVENTION

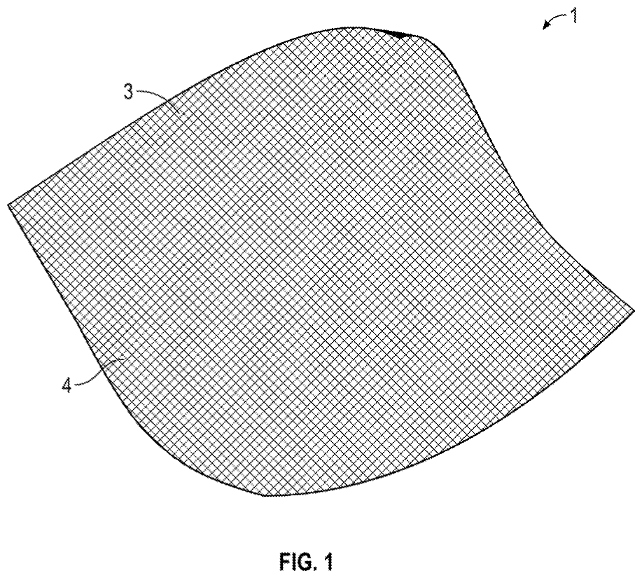

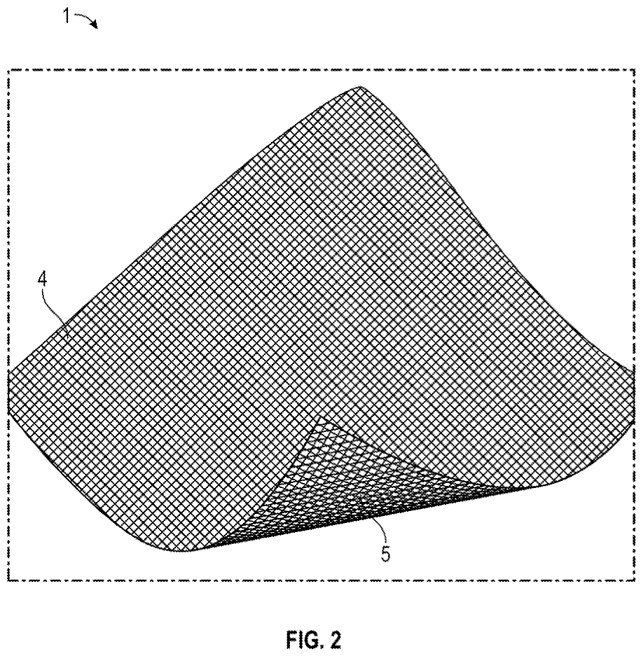

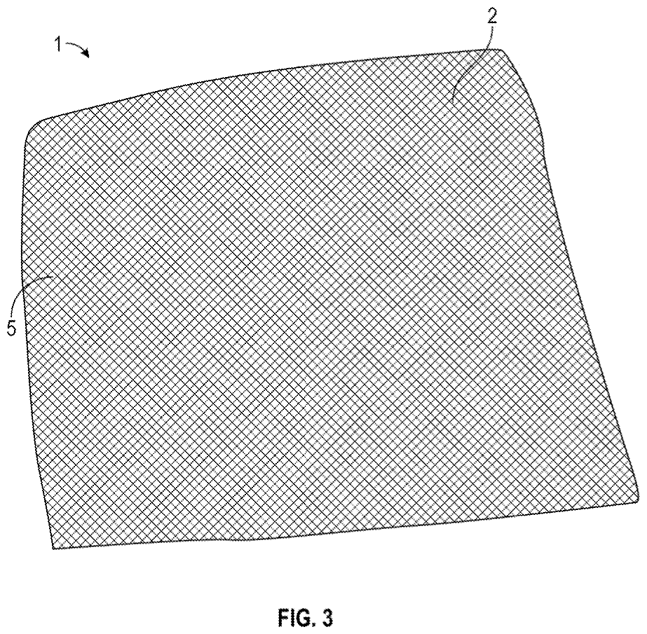

A preferred embodiment of the pliable building membrane 1 of the present invention is shown in FIGS. 1 to 3. It is a non-flammable fabric, in the form of an inorganic fabric 2 defining a first planar side 4 and a second planar side 5 opposite to the first planar side. A halocarbon polymer in the form of a fluorocarbon polymer 3 has been impregnated into the first planar side 4. FIG. 1, and the majority of FIG. 2, show the side 4 of the inorganic fabric into which the fluorocarbon polymer 3 has been impregnated. FIG. 3 shows the opposite side 5, which is simply the raw, untreated, inorganic fabric, upon which a residual amount of fluorocarbon polymer is visible.

In the illustrated embodiment the first planar side 4 has a gloss grey coloured finish and the second planar side 5 has a duller light grey/white coloured finish. However, it will be appreciated that other embodiments may have other finishes. For example, some other embodiments may have alternative colouration, for example due to the inclusion of pigments, dyes and the like.

Various embodiments of the pliable building membrane 1 have differing ratios of halocarbon polymer to non-flammable fabric. For an embodiment featuring a lighter degree of impregnation, this ratio is 0.01:1. For another embodiment featuring a heavier degree of impregnation, this ratio is 1.4:1. It will be appreciated that yet other embodiments feature other ratios, such as between 0.1:1 and 1:1, for example. In the illustrated embodiment, the ratio of halocarbon polymer to non-flammable fabric, by weight, is approximately 1:1. It will be appreciated that a lighter degree of impregnation helps keep costs down through the use of less raw materials. Additionally, a lighter degree of impregnation helps to lower the weight per unit area of the product.

One property of the pliable building membrane 1 that is influenced by the degree of impregnation is its vapour permeability, with a suitable minimum target vapour permeability being approximately 0.15 μg/N·s. The illustrated embodiment, which has a 1:1 ratio, has a vapour permeability of approximately 1 μg/N·s, which is well suited for use of the pliable building membrane 1 as a sarking-type material.

For the illustrated embodiment, the component of weight contributed by the halocarbon polymer that has been impregnated into the non-flammable fabric is approximately 200 grams per square meter (gsm). In this embodiment the halocarbon polymer is polytetrafluoroethylene (PTFE), one formulation of which is generally known by the trade name Teflon. Other embodiments dispense with the use of PTFE and instead utilize other fluorocarbon polymers, such as fluorin plastic, for example. Additionally, to help provide the desired water barrier property, the fluorocarbon impregnation is sufficiently uniform. Yet other options for the halocarbon polymer include ethylene tetrafluoroethylene and/or a tetrafluoroethylene perfluoro propylene co-polymer.

Preferably, the non-flammable fabric 2 that is selected to form the substrate into which the halocarbon polymer 3 is impregnated should be sufficiently malleable so as to be capable of being folded over without breaking.

For the illustrated embodiment the non-flammable fabric substrate is a satin-weave fiberglass fabric, which has a pre-impregnation weight of approximately 200 gsm, thereby yielding the approximate 1:1 ratio mentioned above. The particular satin weave fibreglass fabric used in the illustrated embodiment is commercially available under the trade name alkali-free E-glass. Other embodiments dispense with the use of fibreglass fabric, and instead utilise other non-flammable fabrics, such as basalt fibre fabric, or carbon fibre fabric, for example.

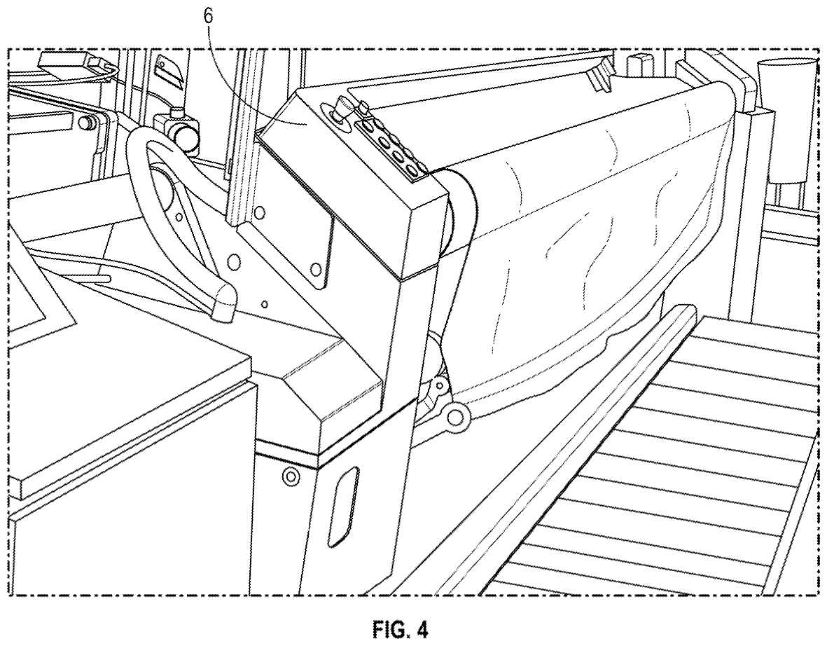

The processing station 6 shown in FIG. 4 may be used to form the pliable building membrane. The processing station 6 is operated so as to impregnate the halocarbon polymer 3 into the non-flammable fabric 2 in a solvent-borne line process. This involves firstly applying the halocarbon polymer 3 to the first planar side 4 of the non-flammable fabric 2. Next, the solvent is heated until it evaporates and thereby concentrates the halocarbon polymer 3 into a solid impregnated into the first planar side 4 of the non-flammable fabric 2. Optionally, indicia may be printed onto second side 5, which may include a trace code, a product identifier and a trademark, for example. It is generally easier to print onto the untreated side 5 of the glass fabric as compared to attempting to print onto the impregnated side 4.

In another embodiment the halocarbon polymer 3 is sprayed onto the non-flammable fabric 2 such that the halocarbon polymer 3 is uniformly dispersed and impregnated into the non-flammable fabric 2.

The applicant has conducted testing of the PTFE impregnated fibreglass fabric pliable building membrane and has found that the product complies with the relevant Australian Standards.

With regard to combustibility, the AS 1530.1 test involves heating a specified volume of the sample in a crucible at 750° C. Significant heat from combustion or flaming will result in it being deemed combustible. The inorganic fabric provides a minimal to non-existent fuel load for combustion. Hence, the fibreglass fabric achieved a result of “not deemed combustible”, which complies with the relevant Australian Standard. To the best of the inventors' knowledge as at the priority date there were no other commercially available vapour permeable building wrap, pliable building membrane or sarking-type material which incorporates a fabric that is not deemed combustible in accordance with AS 1530.1 whilst delivering the material properties of both water vapour permeability and barrier to water.

The AS/NZS 4201.4 test requires a material to resist penetration by liquid for a specified period of time. The PTFE impregnated fibreglass fabric pliable building membrane passed this test under in-house testing.

AS/NZS 4200.1 specifies machine direction and lateral direction tensile strength thresholds for the extra heavy duty (XHD) rating of 13.0 kN/m and 10.5 kN/m respectively. The PTFE impregnated fibreglass fabric pliable building membrane has respective tensile strengths of 71.4 kN/m and 53.5 kN/m, and therefore qualifies for the XHD rating.

AS/NZS 4200.1 defines a vapour permeable membrane as one that has a water vapour transmission rate above 0.1429 μg/N·s. The PTFE impregnated fibreglass fabric pliable building membrane achieved a vapour permeability of 1.5767 μg/N·s under testing at an independent laboratory.

The inclusion of the air barrier classification under AS/NZS 4200.1 is optional. The PTFE impregnated fibreglass fabric pliable building membrane achieves this classification.

Testing for electrical non-conductance is in accordance with AS/NZS 4200.1:2017, clause 5.3.1, which references AS/NZS 3100. The components of the product are non-conductive. The PTFE impregnated fibreglass fabric pliable building membrane is electrically non-conductive.

It has been appreciated by the inventors that there are other considerations applicable to the pliable building membrane 1 in addition to merely complying with the relevant building standards. That is, to meet with commercial acceptance, it is highly desirable for a pliable building membrane 1 to also have the certain properties that provide a degree of user-friendliness, practicality and ease of handling during installation of the product in a typical construction context. These properties include considerations of weight per unit area, pliability/rigidity, tendency to be caught by the breeze, hangability and tear resistance, surface antiglare and sliceability.

With regard to weight, it is desirable to avoid excessively light and excessively heavy membranes. Excessively light membranes are likely to be easily caught by a breeze and the resultant billowing makes installation difficult on windy days. Excessively heavy membranes are difficult for the installers to lift and maneuver. Lighter embodiments of the membrane are typically approximately 200 gsm and heavier embodiments may be up to approximately 540 gsm. The illustrated embodiment, which has a 1:1 ratio of PTFE to fibreglass fabric, has a weight of approximately 400 gsm. This range of 200 gsm to 540 gsm is believed to be suitable for installation purposes, although the lighter end of the range is typically considered preferable.

With regard to tear resistance, the illustrated embodiment of the invention exhibits tear resistance of at least 45 N. This will generally suffice for the membrane to survive the tear loadings typically experienced during installation.

The pliability/rigidity property is considered acceptable if the membrane can be folded back upon itself without breaking. The illustrated embodiment of the invention passes this test.

The surface antiglare property is met by the matte finish of the membrane, which has a suitably low reflectivity. However, in other contexts it is desirable to provide a finish on at least one surface of the membrane with low emissivity in the infra-red spectrum and in such cases a suitable treatment may be employed.

Embodiments of the invention may be utilized in a method of insulating a building. The membrane is typically installed as a sarking-type material into wall cavities and/or roof cavities. This provides a secondary weather barrier that is waterproof, vapour permeable, provides an air barrier and is partially or fully non-combustible. Although not strictly necessary, typically the membrane is installed so that the impregnated side faces inwards when used in walls and it faces downwards when used in roofs.

Various installation requirements for membranes that are to be located under or on top of the bottom chord of roof trusses or ceiling joists in attic roofs with flat ceilings, or below roof rafters but above the ceiling lining, are set out in AS 4200.2:2017, clauses 3.6.1 to 3.6.2.3. The contents of these clauses are incorporated in their entirety by way of reference, but should not be taken as strict limitations on the usage of the invention.

Various installation requirements for membranes that are to be installed into walls are set out in AS 4200.2:2017, clauses 3.7.1 to 3.10. The contents of these clauses are incorporated in their entirety by way of reference but should not be taken as strict limitations on the usage of the invention.

In a typical installation into a wall cavity, the membrane is fastened to the wall frame members prior to the external cladding being applied. It is typically fastened using small nails that puncture the membrane. When the weight of the membrane is hanging from the nail at a puncture point in the membrane, this presents a risk of tearing. The inorganic fabric 2 utilised in the embodiments of invention provides good hangability and tear resistance.

The above examples of the installation of embodiments of the invention relate to the usage of the membrane as a component of walls and roofs of buildings. However, it will be appreciated by those skilled in the art, that other potential usages of the product include the provision of external facing surfaces.

As used in this document, including in the claims, terms such as “impregnated”, “impregnated into”, and the like, are to be construed as including within their scope terms such as “coated”, “coated onto” and the like.

As used in this document, including in the claims, terms such as “partially or fully non-combustible”, and the like, are to be construed as including within their scope terms such “fireproof”, “low combustibility”, “non-flammable” and “non-combustible as defined in the AS 1530.1 test”.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A partially or fully non-combustible and vapour permeable pliable building membrane comprising a halocarbon polymer impregnated non-flammable fabric.

2. A partially or fully non-combustible and vapour permeable pliable building membrane according to claim 1 wherein a ratio of halocarbon polymer to non-flammable fabric, by weight, is between 0.01:1 and 1.4:1.

3. A partially or fully non-combustible and vapour permeable pliable building membrane according to claim 1 wherein a ratio of halocarbon polymer to non-flammable fabric, by weight, is between 0.1:1 and 1:1.

4. A partially or fully non-combustible and vapour permeable pliable building membrane according to claim 1 wherein a ratio of halocarbon polymer to non-flammable fabric, by weight, is approximately 0.4:1.

5. A partially or fully non-combustible and vapour permeable pliable building membrane according to claim 1 wherein the pliable building membrane has a vapour permeability of at least 0.15 μg/N·s.

6. A partially or fully non-combustible and vapour permeable pliable building membrane according to claim 1 wherein the halocarbon polymer contributes a weight per unit area of approximately 200 grams per square meter (gsm) to the building membrane.

7. A partially or fully non-combustible and vapour permeable pliable building membrane according to claim 1 wherein the non-flammable fabric is a fibreglass fabric.

8. A partially or fully non-combustible and vapour permeable pliable building membrane according to claim 7 wherein the fibreglass fabric is a satin weave fibreglass fabric and/or wherein the fibreglass fabric has a weight per unit area of approximately 200 grams per square meter (gsm) prior to being impregnated with the halocarbon polymer.

9. (canceled)

10. A partially or fully non-combustible and vapour permeable pliable building membrane according to claim 1 wherein the non-flammable fabric is a basalt fibre fabric or carbon fibre fabric.

11. A partially or fully non-combustible and vapour permeable pliable building membrane according to claim 1 wherein the halocarbon polymer is polytetrafluoroethylene or wherein the halocarbon polymer is fluorin plastic.

12. (canceled)

13. A partially or fully non-combustible and vapour permeable pliable building membrane according to claim 1 wherein the halocarbon polymer impregnated non-flammable fabric is a fluorocarbon polymer impregnated non-flammable fabric.

14. A partially or fully non-combustible and vapour permeable pliable building membrane according to a claim 1 wherein the non-flammable fabric is an inorganic fabric.

15. A partially or fully non-combustible and vapour permeable pliable building membrane according to claim 1 wherein the halocarbon polymer is ethylene tetrafluoroethylene.

16. A partially or fully non-combustible and vapour permeable pliable building membrane according to claim 1 wherein the halocarbon polymer is a tetrafluoroethylene perfluoro propylene co-polymer.

17. A method of forming a partially or fully non-combustible and vapour permeable pliable building membrane including impregnating a halocarbon polymer into a non-flammable fabric in a solvent-borne line process.

18. A method according to claim 17 including heating the pliable building membrane so as to evaporate the solvent and thereby concentrate the halocarbon polymer into a solid impregnated into the non-flammable fabric.

19. A method according to claim 17 wherein the non-flammable fabric defines a first planar side and a second planar side opposite to the first planar side and wherein the halocarbon polymer is impregnated into the first planar side.

20. A method according to claim 17 wherein the halocarbon polymer is sprayed onto the non-flammable fabric.

21. A method according to claim 17 wherein the building membrane has uniformly dispersed halocarbon polymer impregnated into the non-flammable fabric.

22. A method of providing a secondary weather barrier that is waterproof, vapour permeable, provides an air barrier and is partially or fully non-combustible, the method including using a pliable building membrane comprising a halocarbon polymer impregnated non-flammable fabric as a sarking-type material.
